(19) United States
(12) Patent Application Publication
(10) Pub. No.: US 2018/0108051 A1
(43) Pub. Date: Apr. 19, 2018

(54) SYSTEM FOR PRODUCING SIGNS AND LINKING TO ONLINE SALES LISTIN

(71) Applicant: Sign2Web Inc., Stoney Creek (CA)

(72) Inventors: Martin Walter Rygiel, Stoney Creek (CA); Leszek Wojcianiec, Stoney Creek (CA); Earnest Lukasz Surudo, Stoney Creek (CA)

(21) Appl. No.: 15/726,474

(22) Filed: Oct. 6, 2017

Related U.S. Application Data
(60) Provisional application No. 62/409,433, filed on Oct. 18, 2016.

(51) Int. Cl. G06Q 30/02; G09F 19/22; G06K 19/06; G06Q 30/06; G06Q 50/16

(52) U.S. Cl. CPC G06Q 30/0276; G09F 19/228; G06Q 50/167; G06Q 30/0641; G06K 19/06009

(57) ABSTRACT

The present invention is a method of mass production of signs that begins with random generation of three linked unique identification codes. A generic sign template with preselected areas for inserting the three linked unique identification codes is generated. A computer ghostscript is used to inline the three linked unique identification codes to represent them as simple shapes thereby reducing the file size of the three linked unique identification codes such that the three linked unique identification codes are now adapted to be printed as mass producible images. A PDF file of the sign graphics is created to then print on the sign and a unique validation code is covered such that it is only readable by a purchaser of the sign. The present invention is also a method of advertising a good for sale where there is a physical sign having printed thereon a website address, a unique indicia, a unique web identification code and a unique validation code readable only by a sign purchaser. The unique web identification code and unique validation code are used to validate the sign and render the sign functional. The unique indicia is linked to a selected webpage for display of information regarding the good offered for sale. The unique is optically sensed by an optical sensor which sends a request for the information about the good for sale.

This application claims priority from previously filed U.S. provisional patent application 62/409,433 filed Oct. 18, 2016 by Sign2Web Inc. under the title SYSTEM FOR PRODUCING SIGNS AND LINKING TO ONLINE SALES LISTING.

### FIELD OF THE INVENTION

The present invention relates generally to creating physical signs, each sign contains three unique linked codes such that the sign can be associated with a sales listing and further wherein multiple signs can be linked to a single sales listing.

### BACKGROUND OF THE INVENTION

Sellers of goods and/or services have used physical signs for advertising the sale of goods or the offering of services as a means of drawing attention and advertising the products or services that are being sold. There is a perception that the use of a sign provides a certain exclusivity in that there is a perceived lack of competition for the sale of the good or their offering of the service in association with that particular sign.

Traditionally sellers have purchased generic FOR SALE signs for the sale of, for example, their home or their automobile and have placed their signs proximate to the good and/or the service that is being offered for sale. The drawback of these traditional signs is that only limited information can be conveyed to the purchaser by the sign and normally a telephone number is the only unique information found on the sign to help the prospective purchaser contact the seller for more information.

There have been attempts made to link signs with websites and online information. U.S. Pat. No. 6,853,979 issued Feb. 8, 2005 under the Title: METHOD FOR MARKETING GOODS AND SERVICE, having the inventor, Michael A. Bass and issued to assignee Hy-Ko Products Company is one such method. This patent specification discloses a method of marketing of goods, which includes the steps of the user creating an ad online, providing the user a sign having a pre-printed website address, a unique identifier and an indication that the good is for sale and further providing a website adapted to allow a seller to post information about the goods of the services that are being offered for sale in association with that sign on the website.

The disadvantages associated with the products and services as described in U.S. Pat. No. 6,853,979 to Hy-Ko Products Company is that the purchaser of the sign must physically enter the unique identifier number by hand after the sign has been purchased. The specification alludes to the possibility of having this number pre-printed on to a sign. However to date, the technology does not exist to allow for a unique number to be printed on to each sign in a high production environment.

Further disadvantages of the method as described in the Hy-Ko Products Company U.S. Pat. No. 6,853,979 is that there is no unique validation code provided which would prevent the transfer of the sign to another person nor is there a simple way of scanning the sign through a QR code for prospective purchases to use. In addition, the user is unable to reuse the sign and identifier code or transfer them to another online listing.

Lastly there is no provision in the Hy-Ko Products Company patent for allowing multiple signs to be linked to a single sales listing which is a very important consideration, particularly in the sale of real estate, where at times, numerous signs are required in order to properly market the product. For example, at an open house, there may be as many as four or five signs used to direct traffic to an open house as well as signage at the property that is being sold.

Therefore, there is a need for a system for producing signs wherein each sign contains multiple unique identifier codes which in the case of this application are known as the web identification code, the validation and a QR code, which not only direct purchasers to the web based sales listing information about the item being sold but further also prevents the transfer of the sign to another person.

There is further need for a system wherein multiple signs each having unique identifiers pre-printed on the sign with the capability of being linked to a single listing.

The present invention addresses the deficiencies of the prior art which uses electronic records and corresponding physical signage to advertise and market an item.

### SUMMARY OF THE INVENTION

The present invention is a method of mass production of signs that comprises:
a) random generation of three linked unique identification codes: a unique indicia, a unique web identification code and a unique validation code which have a common link;
b) generate a generic sign template with preselected areas for inserting the unique indicia, the unique web identification code and the unique validation code into the preselected areas;
c) Use a computer ghostscript to inline the three linked unique identification codes to represent them as a simple shape thereby reducing the file size of the three linked unique identification codes such that the three linked unique identification codes are now adapted to be printed as mass producible images;
d) create a PDF file of sign graphics to then print on the sign; and
e) cover the unique validation code such that it is only readable by a purchaser of the sign.

The unique indicia is preferably a quick response (QR) code but may be a barcode instead.

The unique validation code is preferably covered by a sticker that is removed by the purchaser of the sign but could also be covered by a scratchable area.

The generic sign template includes preferably includes an advertising space informing a potential purchaser that a good is for sale. The generic sign template may further include a message space for the purchaser of the sign to write a message.

The advertising space may inform the potential purchaser that the good is real estate or that the good is a vehicle for sale.

The present invention is also a method of advertising a good for sale comprising:
a) providing a physical sign having printed thereon a website address, a unique indicia, a unique web identification code and a unique validation code which is readable only by a sign purchaser;
b) the unique web identification code and unique validation code to be entered at the website address to validate the sign and render the sign functional;
c) link the unique indicia to a selected webpage for display of information regarding the good offered for sale;
d) upload information regarding the good offered for sale which is linked to the unique indicia; and
e) optically sensing the unique indicia with an optical sensor which sends a request for the information about the good for sale.

Preferably the unique indicia is a quick response (QR) code, but it could instead by a barcode.

The selected webpage may be an advertising page provided by the website of the sign manufacturer. The selected webpage could instead be a third party marketplace webpage or a webpage created by the sign purchaser.

The information regarding the good offered for sale includes personal contact information for a seller of the good offered for sale, an image of the good offered for sale and information regarding the condition of the good offered for sale.

Preferably, the optical sensor is a camera on a mobile device.

### BRIEF DESCRIPTION OF THE DRAWINGS

The present concept will now be described by way of example only with reference to the following drawings in which:

FIG. 1 is a flow chart showing the steps for producing signs, each printed with three unique identification codes thereon.

FIG. 2 is a flow chart showing steps for using signs produced as described in FIG. 1

FIG. 3 is a flow chart showing the steps for linking the physical sign to an electronic record to advertise and market goods for services.

FIG. 4 is one example of a physical sign face.

### DETAILED DESCRIPTION OF THE PREFERRED EMBODIMENTS

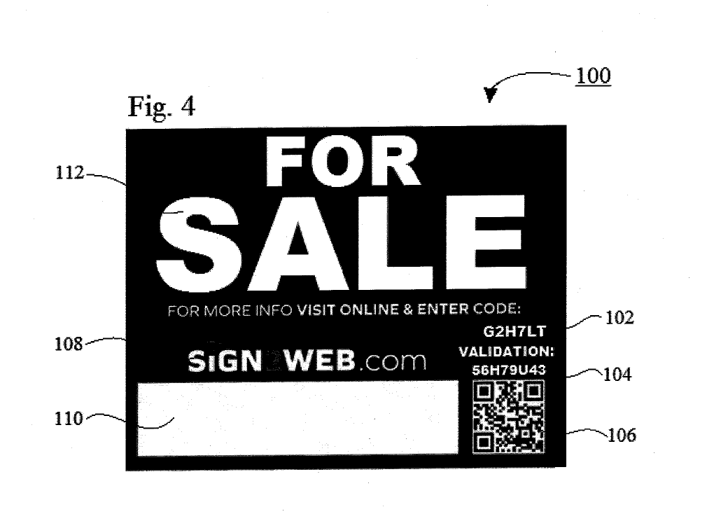

The present concept is a system and method for producing signs. Each sign contains three linked unique identification codes printed on the face of a sign. FIG. 4 is one example of a generic sign 100 depicting on the face three linked unique identification codes, namely the web identification code 102, the validation code 104 and a QR code 106.

Further shown in FIG. 4, sign 100 normally also would display on the face of the sign a generic statement 112 such as FOR SALE, a general web address 108, in this case sign2web.com and finally a user defined space 110 in which the purchaser of the sign could insert by hand any information into the user defined space such as a telephone number and/or other information about the item that is being sold.

Currently there is no technology in place which allows one to print at a high rate of production, signs such as those shown in FIG. 4, wherein there are three linked unique identification codes, each of which are different from one sign to the next.

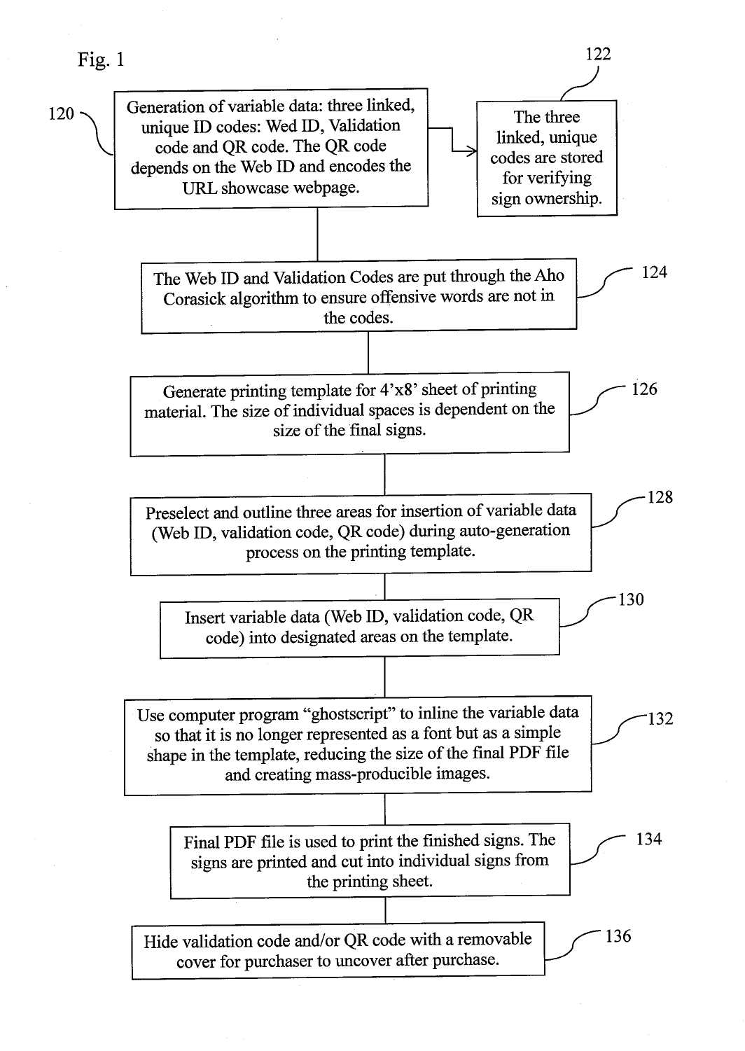

Referring now to FIG. 1, which is a flow chart showing steps involved in producing signs as shown in FIG. 4, each printed with three unique identification codes which are linked.

The steps are as follows:

Generation of the three variable data for each sign, namely the three linked unique identification codes, which are shown in FIG. 4 as the web identification code, the validation code and the QR code. Step 120.

Electronic storage of the three linked unique identification codes for later verification of sign ownership and for direction of inquiries to the appropriate sales listing. Step 122.

The web identification code as well the validation code is put through the Aho Corasick algorithm with a custom dictionary of offensive words and word fragments to ensure offensive words are not part of the codes. Step 124.

A template is generated, for example, a 4×8 sheet of printing material, which includes individual spaces which are sized for the placement of the final signs. Step 126.

For each sign, one pre-selects and outlines three areas for the insertion of the variable data which is generated in step 120, namely the web identification code, the validation code and the QR code, which occurs during the auto generation process for production of the printing templates. Step 128.

The variable data generated in step 120 is inserted into the three preselected and outlined designated areas on the template. Step 130.

A program known as Ghost Script is used to “inline” the variable date generated in step 120 so that the variable data is no longer represented as a font but as a simple shape in the template, thereby reducing the final template of the sign to a final PDF file and creating mass-producible images. Step 132. This allows the PDF templates to be read by specialized printers that may not support custom fonts.

The final PDF file is used to print the final signs and the signs are printed and cut into individual signs from the printing sheets. Step 134.

An easy peel sticker is further attached to the sign to hide the validation code and/or the QR code, which is removed from the sign face by the purchaser of the sign to thereby uncover the validation code and/or the QR code.

In this manner, using this method, physical signs can be printed with each physical sign having three unique linked identification codes printed on the sign, namely the web identification, a validation code and a QR code. Further, each sign has an easy peel sticker covering over the validation code and/or the QR code, thereby preventing registration of the sign without purchase of the sign.

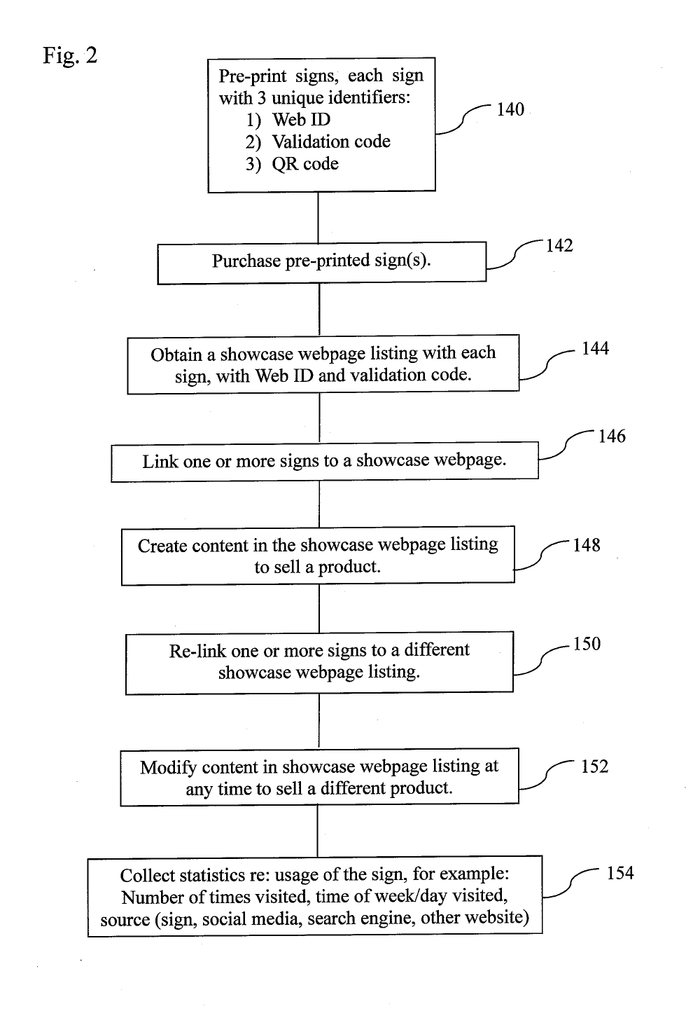

Referring now to FIG. 2, which shows the steps for using signs which are produced as described in FIG. 1.

FIG. 2 is a flowchart showing steps for using the signs which are produced as described in FIG. 1 and includes the following steps:

Signs are pre-printed with the unique linked identifiers, namely the web identification, the validation code and the QR code, as described in FIG. 1 shown as 140.

A person interested in selling an article or providing an advertisement for a service that is provided would purchase one of the pre-printed signs that are printed and produced as described in FIG. 1, shown as 142.

The owner of the pre-printed sign obtains a sales listing, also called a showcase web page and also referred to herein as a showcase webpage listing, which corresponds to the sign by entering the web identification number and the validation code, shown as 144. The showcase webpage listing may be one listed on the sign manufacturer's website or one accessed at a third-party website.

If more than one sign has been purchased, it is possible to link one or more signs to a single sales listing or showcase webpage shown as 146.

The owner of the sign can create content in the showcase webpage or the sales listing to sell a product or offer a service for sale, shown as 148.

At any time, the owner of the signs can relink one or more of his or hers signs to different showcase webpage listings, shown as 150.

At any time the owner of the sign can modify content in the showcase webpage listing to sell a different product or to enhance the existing sales listing information, shown as 152.

Furthermore, statistical information from the traffic generated to the showcase webpage listing is collected. The information collected pertains to the usage of the sign, such as the number of times the sign is visited, the time of day or day of the week the sign is visited and the source of traffic to the showcase webpage listing (from sign QR code, social media, search engine or third-party website), shown as 154.

Please be aware that as used herein, the word sales listing, showcase webpage and showcase webpage listing all refer to the same thing.

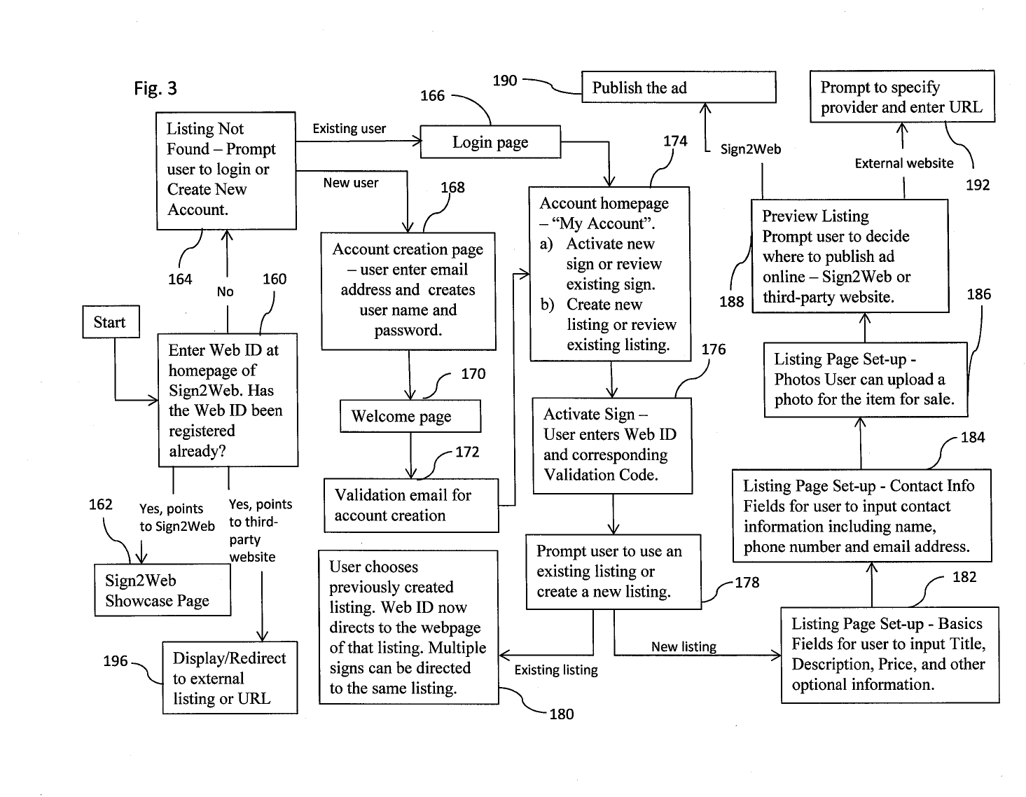

Referring now to FIG. 3, which is a flowchart showing the steps for linking the physical sign to an electronic record for the purpose of advertising goods or services. The steps involved are as follows:

The purchaser of the sign will enter the web identification at the home page 160 assigned to web and if the purchaser has already registered the sign, it will take him directly to the showcase page which contains a description of the item, seller information, price, and terms of sale, shown as 162. It is also possible for the Web ID and/or QR code to redirect to a showcase webpage listing hosted by a third-party website. When the purchaser enters the WebID at the homepage or an interested buyer scans the QR code, they are taken to an ad or listing at an external website or URL, shown as 196.

On the other hand, if the purchaser of the sign has not yet already registered the sign and the listing is not found, it will prompt the user to create a new account, shown as 164.

If in fact, it is a new user, the user will create a new account by entering the email address and password to create a new account, shown as 168.

At that point, the user will be taken to a welcome page, shown as 170.

There will be a request for validation of the email for the account creation, shown as 172, to eliminate the possibility of using the system to send spam.

From there the user will be taken to an account home page, wherein the user can either activate a new sign or review an existing sign or create a new listing or review an existing listing, shown as 174.

In the case that the user has already logged in and already has an account, they will go straight to the login page, shown as 166.

The user then can activate a new sign by entering the web identification and the corresponding validation code, which is uncovered on the face of the sign, shown as 176.

The user will then be prompted to link the sign to an existing listing or create a new listing, shown as 178. If the user chooses to use a previously created listing, the web identification number will now direct that sign to the existing showcase page. It is also possible to link multiple signs to the same showcase page, shown as 180.

In the event that the user wants to create a new listing, they will be sent to a page to input basic setup information, including the title, description, price and other optional information about the item to be sold, shown as 182.

The user can also choose certain contact information and insert phone numbers, email address for contacting the seller, shown as 184.

The user will also be prompted to upload photographs or other information about the item for sale, shown as 186.

Ultimately the user can preview the showcase page before it is published and edit the showcase page until they are happy with it, shown as 188. At this stage, the user is also prompted to choose if the ad is posted on the sign manufacturer's website, in this case Sign2Web.com, or published to a third-party website.

If the user chooses to publish the ad on a third-party website, the user is prompted to specify an external provider and enter a URL, shown as 192.

If the user chooses to publish the ad with the sign manufacturer, the showcase webpage listing is created using the listing page set-up information and photo provided and published to the sign manufacturer website, shown as 190.

In summary, the concept of the present invention incorporates both a physical product, namely the FOR SALE sign and a digital service, which is a software driven application over a website. This combination yields a versatile, economical and effective outdoor and/or indoor marketing solution to every day consumers and provides an enhanced point of sale experience for the end user versus a traditional for sale by owner sign. The signs can be applied to market anything such as a house, rental property, boat, car, RV, etc. A product ad corresponding to the sign is created by the client and hosted on sign2web.com. The end user, namely the product purchaser, can access information on the product by scanning the QR code on the front of the sign, or entering the unique web ID through the website. The information is displayed online using a variety of templates depending on the product being sold or via a third-party website. After viewing the product, the end user can contact the vendor by email or phone to complete the purchase.

A buyer is only able to access information on sign2web.com if they have a specific product code and/or if they were able to scan the QR on the front of the sign. The unique web identification code and/or QR code can be entered at sign2web.com to view the ad or simply with a cell phone scanning the QR code. This will take the buyer to the showcase page created by the seller. The seller has the option to display the sale information using an external, third-party website instead of publishing an ad to sign2web.com. Instead of being directed to a sign2web.com showcase page, the buyer is directed to an ad listing on a third-party website when the buyer scans the QR code or enters the unique web identification code at sign2web.com. This preserves the exclusive marketing for every client that purchases a sign to a product since no other products can be viewed without further input of either a web identification or QR code. Some of the benefits of this product are as follows:

The sign can be reused by the purchaser of the sign for any outdoor sale and for almost any product. The purchaser of the sign owns both the physical sign and the web identification code, which is essentially the hosting service. The validation code, allows the sign through a retail channel which prevents unwanted activation inside the store.

The database of ads cannot be searched without a code, making the product exclusive. The sign is less likely to be stolen as it is digitally registered to the client and cannot be used by anybody else. The purchaser of a sign will also have access to additional marketing data such as view count and other statistical factors.

The QR code can be scanned by any third party smartphone application and is designed to be scannable from a distance that allows the end user to scan from their vehicle.

The QR code and unique web identification code can be used to direct potential buyers to any webpage or ad listing the seller chooses. The seller is able to use the sign with any website of his or her choice. For example, a real estate agent would be able to use sign to point to a listing on his or her own commercial website.

Multiple signs can be linked to a single sales listing or showcase page. This is particularly useful for real estate marketing since, for example, during an open house signs may be place at numerous locations along the roadway directing interested parties to the property. Additionally, signs may be placed on the lawn and at different locations around the property to ensure that there is full exposure of the property to the buying public.

Other benefits and advantages to the present concept are readily apparent to those skilled in the art and has been disclosed in the present application.

I claim:

1. A method of mass production of signs comprises:
a) random generation of three linked unique identification codes: a unique indicia, a unique web identification code and a unique validation code which have a common link;
b) generate a generic sign template with preselected areas for inserting the unique indicia, the unique web identification code and the unique validation code into the preselected areas;
c) Use a computer ghostscript to inline the three linked unique identification codes to represent them as a simple shape thereby reducing the file size of the three linked unique identification codes such that the three linked unique identification codes are now adapted to be printed as mass producible images;
d) create a PDF file of sign graphics to then print on the sign; and
e) cover the unique validation code such that it is only readable by a purchaser of the sign.

2. The method as per claim 1 wherein the unique indicia is a quick response (QR) code.

3. The method as per claim 1 wherein the unique indicia is a barcode.

4. The method as per claim 1 wherein the unique validation code is covered by a sticker that is removed by the purchaser of the sign.

5. The method as per claim 1 wherein the unique validation code is covered by a scratchable area that is removed by the purchaser of the sign.

6. The method as per claim 1 wherein the generic sign template includes an advertising space informing a potential purchaser that a good is for sale.

7. The method as per claim 6 wherein the generic sign template further includes a message space for the purchaser of the sign to write a message.

8. The method as per claim 6 wherein the advertising space informs the potential purchaser that the good is real estate.

9. The method as per claim 6 wherein the advertising space informs the potential purchaser that the good is a vehicle.

10. A method of advertising a good for sale comprising:
a) providing a physical sign having printed thereon a website address, a unique indicia, a unique web identification code and a unique validation code which is readable only by a sign purchaser;
b) the unique web identification code and unique validation code to be entered at the website address to validate the sign and render the sign functional;
c) link the unique indicia to a selected webpage for display of information regarding the good, offered for sale;
d) upload information regarding the good offered for sale which is linked to the unique indicia; and
e) optically sensing the unique indicia with an optical sensor which sends a request for the information about the good for sale.

11. The method as per claim 10 wherein the unique indicia is a quick response (QR) code.

12. The method as per claim 10 wherein the unique indicia is a barcode.

13. The method as per claim 10 wherein the selected webpage is an advertising page at a sign manufacturer website.

14. The method as per claim 10 wherein the selected webpage is a third-party marketplace seller webpage.

15. The method as per claim 10 wherein the selected webpage is a webpage created by the sign purchaser.

16. The method as per claim 10 wherein the information regarding the good offered for sale includes personal contact information for a seller of the good offered for sale, an image of the good offered for sale and information regarding the condition of the good offered for sale.

17. The method as per claim 10 wherein the optical sensor is a camera on a mobile device.
